(19) United States
(12) Patent Application Publication
(10) Pub. No.: US 2023/0194408 A1
(43) Pub. Date: Jun. 22, 2023

(54) DUST SENSOR

(71) Applicant: LG ELECTRONICS INC., Seoul (KR)

(72) Inventors: Jinhee NOH, Seoul (KR); Seongji KANG, Seoul (KR)

(21) Appl. No.: 17/918,399

(22) PCT Filed: Apr. 7, 2021
(86) PCT No.: PCT/KR2021/004372

§ 371 Date: Oct. 12, 2022

(30) Foreign Application Priority Data
Apr. 17, 2020 (KR) 10-2020-0046348

(51) Int. Cl. G01N 15/14

(52) U.S. Cl. CPC G01N 15/1434; G01N 2015/1493

(57) ABSTRACT

The present invention relates to a dust sensor comprising; a case having an air inlet and an air outlet, an air flow path which is formed inside the case, of which one end is connected to the air inlet, and of which the other end is connected to the air outlet, and which comprises first and second flow paths that have different air flow directions, a wind-blowing fan arranged on the air flow path, a first sensing module which is arranged on the air flow path and which senses dust particles in the air, and a second sensing module, which is arranged on the air flow path, arranged further downstream than the first sensing module, and senses dust particles that are smaller than the dust particles sensed by the first sensing module, and thus, the present invention can accurately measure both large dust particles and small dust particles present in the air.

### TECHNICAL FIELD

The present disclosure relates to a dust sensor, and more particularly, to an optical dust sensor that senses dust present in the air by radiating light.

### BACKGROUND ART

Recently, various problems have been raised regarding fine dust, and research on dust sensors for measuring the fine dust has been actively conducted.

A dust sensor is a device that measures an amount or concentration of dust particles included in the air. An optical sensor is widely used as the dust sensor. The optical dust sensor irradiates the air with light and detects light scattered by the dust to measure an amount of dust. Dust sensors are classified in various ways according to a type of radiated light.

Examples of the dust sensor include a sensor using a light emitting diode (LED) light emitting element or an infrared light emitting element. Such a sensor includes a light source unit configured of an LED element, a light reception unit such as a photodiode (PD), and a lens for condensing light scattered by dust in the air.

However, since the sensor radiates light in a visible region or an infrared region, there is a disadvantage that the sensor cannot adroitly measure fine dust, which is smaller in size than a wavelength of the light.

Meanwhile, examples of the dust sensor include a dust sensor that senses dust by radiating laser light. In such a scheme, a light source unit radiates a laser instead of radiating visible light or light in an infrared region. This scheme has an advantage that fine dust having a small size is easily measured.

However, since a laser dust sensor has a narrow light radiation scope, there is a problem in that a measurement error is significant in the case of large dust particles outside the light radiation scope. For example, it can be seen from FIG. 6 that the laser dust sensor provides substantially the same value as an actual measurement value at PM1.0, causes a slight error at PM2.5, and provides a significantly different value from the actual measurement value at PM10.

That is, according to the related art, a dust sensor for a visible or infrared region must be disposed to measure large dust particles or a laser dust sensor must be disposed to measure small dust particles, and there is a problem that the large dust particles and the small dust particles present in the air cannot be measured at the same time.

### SUMMARY

An object of the present disclosure is to provide a dust sensor capable of accurately measuring large dust particles and fine dust particles present in the air at the same time.

Another object of the present disclosure is to provide a dust sensor capable of measuring individual sizes of dust particles while measuring a total concentration of dust.

Objects of the present disclosure are not limited to the objects mentioned above, and other objects not mentioned will be clearly understood by those skilled in the art from the following description.

In order to achieve the above object, a dust sensor according to an aspect of the present disclosure includes a case having an air inlet and an air outlet formed therein; an air flow path formed inside the case, having one end connected to the air inlet and the other end connected to the air outlet, and including a first flow path and a second flow path having different air flow directions; a wind-blowing fan disposed on the air flow path; a first sensing module disposed on the air flow path and configured to sense dust particles in the air; and a second sensing module disposed on the air flow path, disposed downstream from the first sensing module, and configured to sense dust particles smaller than those sensed by the first sensing module.

The second flow path may extend in a direction different from a direction in which the first flow path extends, the first sensing module may be disposed on the first flow path, and the second sensing module may be disposed on the second flow path.

The first flow path may include a first upper flow path having an inlet end communicating with the air inlet, formed to have a constant cross-sectional area, and having the first sensing module disposed thereon; and a first lower flow path having an inlet end communicating with the first upper flow path, an outlet end of the first lower flow path having a cross-sectional area smaller than the inlet end.

The first flow path may include an upper end communicating with the air inlet, extend downward, and include a lower end communicating with the second flow path.

The first sensing module may include a first light emitting member disposed on a side surface of the air flow path and configured to radiate first light from the side; and a first light reception member disposed in a direction intersecting both an irradiation direction of the first light emitting member and the air flow direction and configured to sense the first light.

The second sensing module may include a second light emitting member disposed on a side surface of the air flow path and configured to radiate second light from the side; and a second light reception member disposed in a direction intersecting both an irradiation direction of the second light emitting member and the air flow direction and configured to sense the second light.

The wind-blowing fan may be disposed closer to the air outlet relative to the air inlet.

The air flow path may further include a third flow path communicating with an outlet end of the second flow path, and the wind-blowing fan may be disposed on the third flow path.

The air flow path may include a first flow path connected to the air inlet; a third flow path connected to the air outlet and facing the first flow path; and a second flow path connecting the first flow path to the third flow path.

Details of other embodiments are included in the detailed description and drawings.

### ADVANTAGEOUS EFFECTS

According to the dust sensor of the present disclosure, there are one or more effects:

First, there is an advantage that the first sensing module senses relatively large dust particles in the first flow path disposed upstream, and the second sensing module detects relatively small dust particles in the second flow path disposed downstream, such that dust particles having various sizes present in the air having a specific volume are measured at the same time and the accuracy is improved.

Second, there is also an advantage that, since the first flow path and the second flow path have different air flow directions, large dust particles collide with a wall of the first curved flow path according to inertial force and are captured in the first curved flow path connecting the first flow path to the second flow path, thereby reducing an error when the second sensing module operates.

Third, there is also an advantage that, since the air turns in the first curved flow path, large dust particles are captured on an outer side wall of the first curved flow path according to centripetal force, thereby reducing an error when the second sensing module operates.

Effects of the present disclosure are not limited to the above-mentioned effects, and other effects not mentioned will be clearly understood by those skilled in the art from the description of the claims.

### BRIEF DESCRIPTION OF THE DRAWINGS

FIG. 1 is a front view schematically illustrating an internal structure of a dust sensor according to the present disclosure.

FIG. 2 is an enlarged view of a first flow path portion in FIG. 1.

FIG. 3 is a diagram illustrating an example of a measurement method and a measurement result of a first sensing module.

FIG. 4 is an enlarged view of a second flow path portion in FIG. 1.

FIG. 5 is a diagram illustrating an example of a measurement method and a measurement result of a second sensing module.

FIGS. 6A to 6C are diagrams illustrating a dust particle measurement result of the second sensing module for each of the sizes of dust particles.

### DESCRIPTION OF EXEMPLARY EMBODIMENTS

Advantages and characteristics of the present disclosure, and a method of achieving these will become apparent with reference to embodiments described below in detail in conjunction with the accompanying drawings. However, the present disclosure is not limited to the embodiments disclosed below, but may be implemented in various different forms, these embodiments are merely provided to allow the disclosure of the present disclosure to be complete and to fully inform those skilled in the art to which the present disclosure pertains of the scope of the disclosure, and the present disclosure is only defined by the scope of the claims. The same components are denoted by the same reference signs throughout the present disclosure.

Hereinafter, the present disclosure will be described with reference to the drawings for describing dust sensors according to embodiments of the present disclosure.

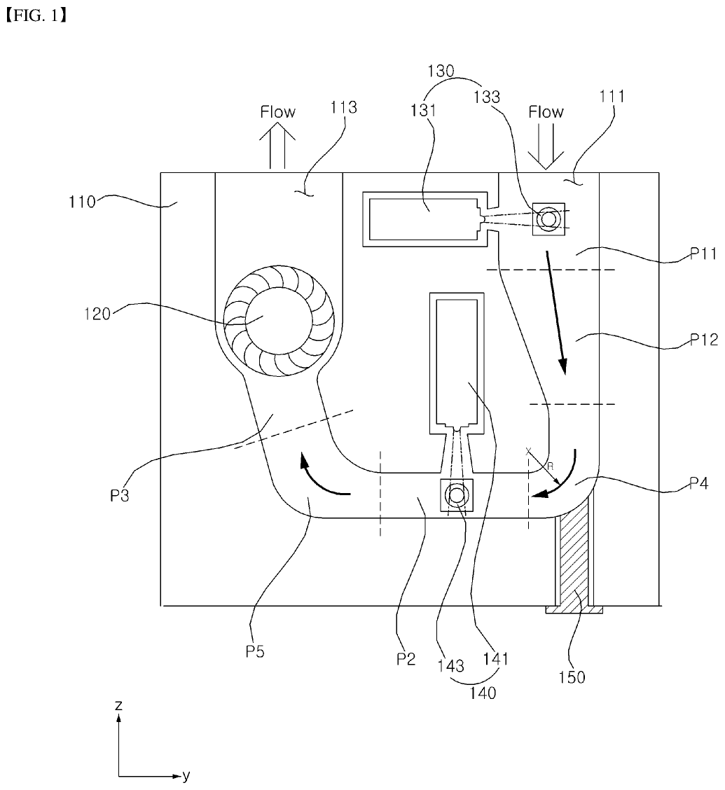

Referring to FIG. 1, FIG. 1 is a front view, and a front side of FIG. 1 is a front side of the dust sensor. An upper side of the dust sensor in FIG. 1 is upward. A first light emitting member 131 or a second light emitting member 141 is disposed on the inner side of the air flow path P with reference to an air flow path P. A side surface of a case 110 is disposed on the outer side of the air flow path P.

FIG. 1 is a view illustrating a dust sensor according to the present disclosure. The dust sensor measures an amount or concentration of dust particles included in the air.

The dust sensor according to the present disclosure is an optical sensor that radiates light to sense dust. The optical sensor irradiates the air with the light, the radiated light collides with the dust such that a part of the light is reflected, diffracted, or scattered, and the optical sensor senses the reflected, diffracted, or scattered light to measure a size or amount of the dust.

The dust sensor according to the present disclosure measures a wide range of dust. Recently, dust particles present in the air are classified into various types such as fine dust or ultra-fine dust. In the air, the dust particles are classified into general dust particles, fine dust configured of particles smaller than the general dust particles, and ultra-fine dust configured of particles smaller than the fine dust particles. Since the fine dust or the ultra-fine dust has particles much smaller than other dust particles, there are problems that it is difficult to design a dust sensor capable of measuring the general dust, the fine dust, and the ultra-fine dust at once, and the accuracy of measurement of only the fine dust or the ultra-fine dust is degraded due to significant noise.

Therefore, the present disclosure provides a dust sensor capable of classifying dust into general dust, fine dust, and ultra-fine dust, adopting types of sensors capable of measuring corresponding dust particles within a classification range, and accurately measuring dust particles having various sizes for each size.

Further, in the dust sensor according to the present disclosure, the air flow path P is disposed so that dust particles can be accurately measured for each size of the dust particles, and different types of sensors are disposed on each air flow path P.

More specifically, the dust sensor according to the present disclosure includes at least two sensing modules. Among the sensing modules, a first sensing module 130 senses relatively large dust particles, and a second sensing module 140 senses relatively small dust particles. This makes it possible to measure dust particles having various sizes present in the air.

Recently, the classification of dust particles in the air has been subdivided with the development of measurement technology. Recently, dust particles are classified into PM10, PM2.5, and PM1.0, and PM2.5 among the classified PMs is mainly studied.

PM10 refers to dust particles with a diameter of 10 μm or less. PM10 is referred to as coarse particulate matter in English. PM10 can be sensed by using an infrared dust sensor or an LED dust sensor. However, in the case of the laser dust sensor, since a light radiation scope is narrower than a size of PM10 dust particles, there is a problem in that PM10 dust cannot be accurately sensed.

PM2.5 refers to dust particles with a diameter of 2.5 μm or less. PM2.5 is referred to as fine particulate matter in English and is usually classified as fine dust in Korea. PM2.5 can be sensed by using an infrared dust sensor or an LED dust sensor. However, In the case of the infrared dust sensor or the LED dust sensor, since the intensity of a signal increases or decreases according to a total amount of dust particles within a scope, there is a problem in that it is difficult to sense the number or sizes of individual dusts. The laser dust sensor can sense PM2.5 dust particles with some accuracy even though there is a slight error.

PM1.0 refers to dust particles with a diameter of 1.0 μm or less. PM1.0 is referred to as ultra-fine particulate matter in English and is usually classified as ultra-fine dust in Korea. Since PM1.0 has a very small particle size, there is a problem that it is difficult to sense PM1.0 by using an infrared dust sensor or an LED dust sensor. However, ultra-fine dust corresponding to PM1.0 can be sensed by a laser dust sensor.

The dust sensor according to the present disclosure includes several types of sensing modules.

According to an embodiment, the first sensing module 130 may be an infrared dust sensor or an LED dust sensor. The first sensing module 130 cannot sense ultra-fine dust of PM1.0, but can sense dust of PM10 or PM2.5.

Further, the second sensing module 140 may be a laser dust sensor. The second sensing module 140 has a problem that a significant error occurs when the second sensing module 140 senses large particles of PM10, but can accurately sense dust of PM2.5 or PM1.0.

The dust sensor according to the present disclosure includes a first sensing sensor that senses dust particles having a relatively large size of about PM2.5 to PM10, and a second sensing sensor that senses dust particles having a relatively small size of PM2.5 or less, and can accurately determine various ranges of dust included in the air at once.

The dust sensor according to the present disclosure is an optical sensor that senses dust by radiating light. The optical sensor senses an angle or intensity of light reflected, diffracted, or scattered due to collision of the radiated light with the dust to measure a size or amount of dust. There are various theories related to reflection, diffraction, scattering of light, but Fraunhofer theory, Mie scattering theory, Rayleigh scattering theory, and the like are mainly discussed at present.

Fraunhofer theory is a theory that an angle at which a particle is diffracted due to irradiation with a laser depends on a size of the particle. For example, when a large dust particle is irradiated with the laser, light with a high intensity is diffracted at a small angle, and when a small dust particle is irradiated with the laser, light with a low intensity is diffracted at a large angle.

According to Mie scattering theory, scattering occurs when a size of a particle that scatters light is similar to a wavelength of incident light. According to Rayleigh scattering theory, scattering occurs when the size of the particle that scatters light is much smaller than the wavelength of the incident light. A scattering parameter is proportional to the size of the particle and is inversely proportional to the wavelength of the light. According to Mie scattering theory, when a size of a particle is large, light is scattered with the light biased backward relative to forward. On the other hand, according to Rayleigh scattering theory, when a size of a particle is small, light is scattered evenly forward and backward.

According to the above-described theories, a diffraction angle, a scattering angle, or the intensity of light depends on a size of a dust particle. For example, when the dust particle is large, an angle of scattered or diffracted light is small and the intensity of the light is relatively high. On the other hand, when the dust particle is small, the angle of scattered or diffracted light is large and the intensity of the light is relatively low. When a density of dust particles in the air is high, the angle of scattered or diffracted light becomes large. A light reception member may sense sizes and density of dust particles according to angle change or intensity of detected light.

Referring to FIG. 1, the dust sensor according to the present disclosure is a sensor that radiates light to the air, detects that the radiated light is reflected by fine dust, and senses dust particles present in the air. The dust sensor may include a light emitting member that radiates light, and a light reception member that detects light. The dust sensor may further include a condensing lens that condenses light at a stage before the light reception member, and a blowing module that causes an air flow.

The light emitting member irradiates the air with light. Referring to FIG. 1, the light emitting member according to the present disclosure includes a first light emitting member 131 that irradiates a first flow path P1 with first light, and the second light emitting member 141 that irradiates a second flow path P2 with second light. The radiated light may collide with dust particles and be reflected, scattered, and diffracted. The light emitting member may radiate various types of light. The light emitting member may radiate infrared light, may radiate light in a visible region, or may irradiate a laser.

The light reception member senses reflected, scattered, or diffracted light. Referring to FIG. 1, the light reception member according to the present disclosure includes a first light reception member 132 that senses the first light in the first flow path P1, and a second light reception unit 142 that senses the second light in the second flow path P2. The light reception member outputs an electrical signal corresponding to a dust concentration according to the intensity of the detected light.

The light reception member is disposed to deviate from a range in which the light emitting member radiates light. Therefore, the light reception member cannot detect the light when the light is not scattered due to the absence of dust in the air, and the light reception member can detect the light only when the light is scattered due to the presence of the dust in the air.

The light reception member may be a photodiode, and outputs an electrical signal corresponding to the detected light. In other words, the light reception member outputs an electrical signal corresponding to the dust concentration.

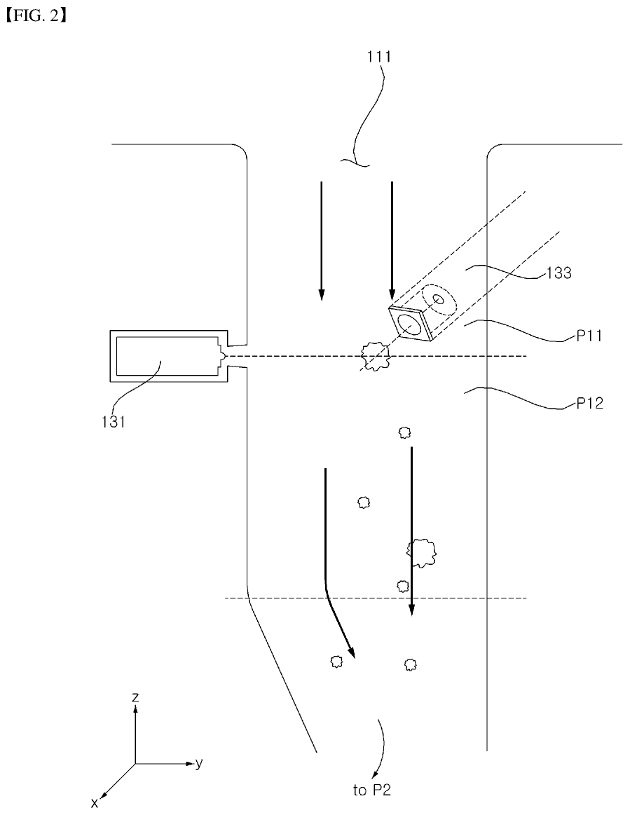

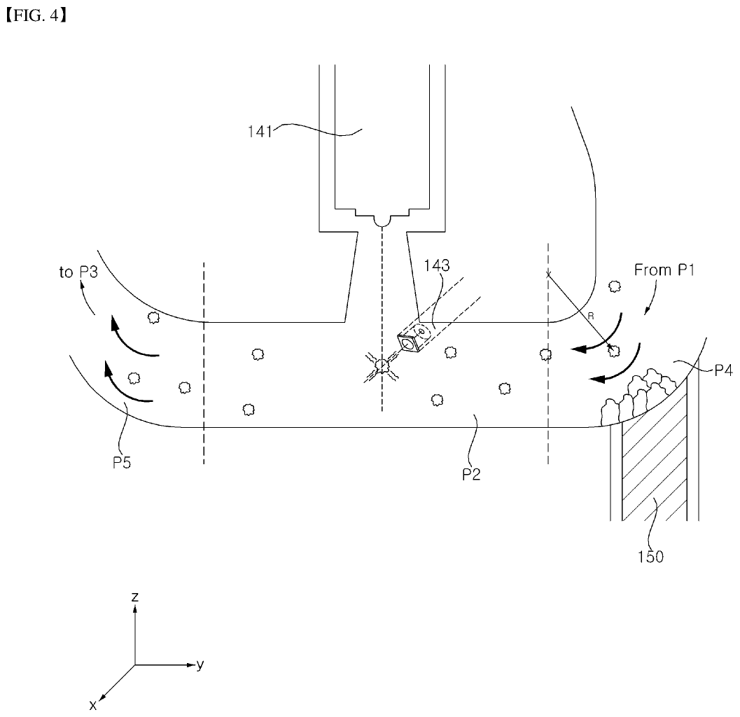

The dust sensor may include the condensing lens. The condensing lens condenses the light radiated from the light emitting member and scattered by the dust particles in the air. Although not illustrated, a first condensing lens that condenses the first light may be disposed between the dust particles and the first light reception member 132 in FIG. 2, and a second condensing lens that condenses the second light may be disposed between the dust particles and the second light reception member 142 in FIG. 4.

Examples of the blowing module installed in the dust sensor include a heater and a wind-blowing fan 120. When the heater operates, heated air rises. The dust particles present on the air flow path P rise due to heat generated by the heater. When the raised dust particles reach the light radiation scope of the light emitting member, the dust particles scatter the radiated light. Alternatively, the wind-blowing fan 120 may be disposed in the dust sensor to cause an air flow.

Referring to FIG. 1, the dust sensor according to the present disclosure may include the wind-blowing fan 120. The wind-blowing fan 120 generates an air flow using a fan and a motor.

Although not illustrated, the dust sensor according to the present disclosure may include a heater. When the heater operates, heated air rises. The dust particles present on the air flow path P rise due to the heat generated by the heater. When the raised dust particles reach the light radiation scope of the light emitting member, dust particles scatter the radiated light.

The first sensing module 130 may be an LED dust sensor that radiates light in a visible region. The first sensing module 130 is a sensor that irradiates the air with first light, and senses light reflected by fine dust to sense dust particles in the air. The first sensing module 130 is disposed on the air flow path P and senses the dust particles in the air.

Referring to FIG. 2, the first sensing module 130 includes a first light emitting member 131 and a first light reception member 133.

The first light emitting member 131 radiates the first light to the air. The first radiated light may collide with the dust particles and be reflected, scattered, or diffracted.

The first light reception member 133 senses the first reflected, scattered, or diffracted light. The first light reception member 133 receives the first light and outputs an electrical signal corresponding to the dust concentration.

The first light reception member 133 may be a photodiode that detects the light in a visible region, and outputs an electrical signal corresponding to the detected light. In other words, the first light reception member 133 outputs an electrical signal corresponding to the dust concentration.

The first sensing module 130 may include a condensing lens. The condensing lens condenses the light radiated by the first light emitting member 131 and scattered by dust particles in the air.

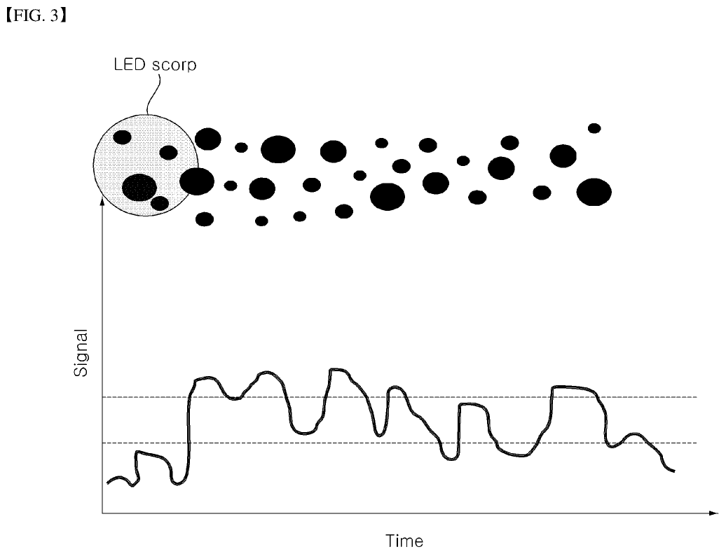

Referring to FIG. 3, the first sensing module 130 measures the intensity of the scattered light and outputs an electrical signal according to the intensity of the light. In the case of the first sensing module 130, the output is in the form of a sum of all dust sizes present in a scope, and appears as an analog graph in which values are connected to each other.

The first sensing module 130 is advantageous for measurement of large dust particles because a sensing area is wide even though the intensity of light is low. On the other hand, the first sensing module 130 has a disadvantage that the first sensing module 130 cannot measure small dust particles due to low precision.

Further, the first sensing module 130 has a disadvantage that individual dust particles cannot be distinguished because a signal output appears in a temporally continuous analog form. The first sensing module 130 has another disadvantage that noise may be included because natural light may be mixed.

According to the present disclosure, the first sensing module 130 senses relatively large dust particles of 2.5 μm or more.

The second sensing module 140 may be a laser dust sensor that radiates a laser. The laser dust sensor is a sensor that radiates laser light into the air and senses light reflected by fine dust to sense dust particles in the air. The second sensing module 140 is disposed on the air flow path P and senses the dust particles in the air.

The second sensing module 140 is disposed downstream from the first sensing module 130. The second sensing module 140 senses dust particles smaller than the dust particles sensed by the first sensing module 130. For example, the second sensing module 140 may sense dust particles having a relatively small size of 2.5 μm or less.

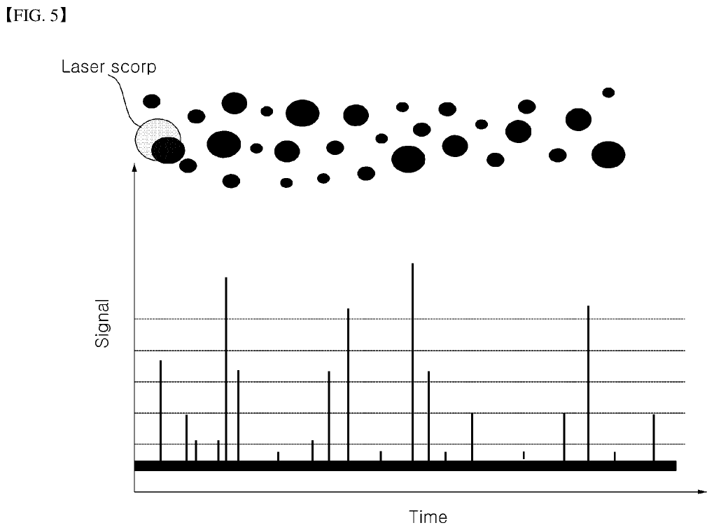

Referring to FIG. 5, the second sensing module 140 includes the second light emitting member 141 and a second light reception member 143.

The second light emitting member 141 irradiates the air with a laser. The irradiated laser collides with dust particles and is reflected, diffracted, or scattered.

The second light reception member 143 senses the reflected, diffracted, or scattered laser light. The second light reception member 143 may measure change in angle of the laser to calculate sizes of the dust particles.

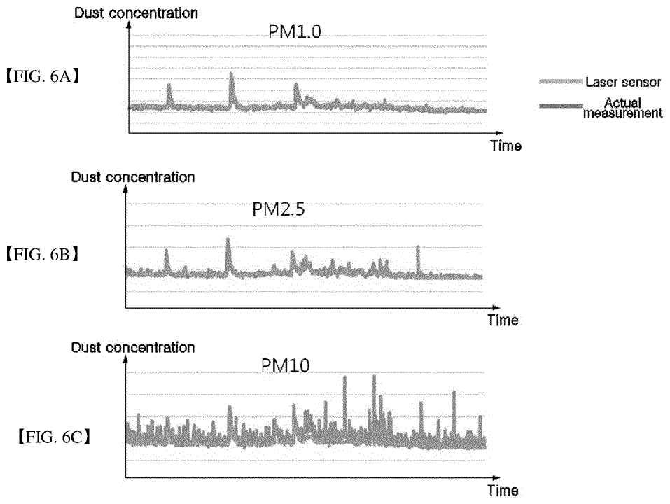

Referring to FIG. 6, the second sensing module 140 may also sense the sizes of dust particles according to the intensity of the light detected by the second light reception member 143, or may measure change in angle of the light reaching the second light reception member 143 to sense the sizes of dust particles. The second light emitting member 141 generates an output for each individual dust, and the output appears as a digital graph in which values are not connected to each other.

The second sensing module 140 has an advantage that the second sensing module 140 has a high energy density and is advantageous for measurement of smaller dust particles as compared with the first sensing module 130 described above. On the other hand, the second sensing module 140 has a disadvantage that the second sensing module 140 is disadvantageous for measurement of large dust particles due to a narrow sensing area.

Since an output of the second sensing module 140 is displayed for each dust particle, the second sensing module 140 has an advantage that the second sensing module 140 can more accurately sense the number and size of dust as compared to the first sensing module 130. However, the second sensing module 140 has a disadvantage that it is difficult to accurately ascertain dust of too large particles such as PM10 because an irradiation scope is narrow.

In particular, it can be seen from FIG. 6 that the second sensing module 140 has poor accuracy at PM10. Referring to FIG. 6, a bold graph shows a measurement value of the second sensing module 140 over time, and a thin graph shows a measurement value of actually measured dust over time. That is, in the case of PM1.0 or PM2.5, a measurement result of the second sensing module 140 and an actual measurement value of the dust show a similar pattern, and it can be seen that certain accuracy is secured. However, in the case of PM10, the measurement result of the second sensing module 140 and the actual measurement value of the dust are very different from each other, and it can be seen that the accuracy of the second sensing module 140 is degraded in the case of PM10. This means that the second sensing module 140 cannot accurately ascertain the size of the dust because the light radiation scope of the second sensing module 140 is narrow, but the dust particles are very large.

The dust sensor according to the present disclosure includes the case 110. The case 110 forms an appearance of the dust sensor and forms an internal space in which components are disposed. The case 110 forms the air flow path P through which air flows therein.

The case 110 includes an air inlet 111. The air inlet 111 is a component that introduces air to be sensed into the inside of the case 110. The air inlet 111 may be disposed on one side of the case 110 and formed to penetrate a wall of the case 110. The air inlet 111 is connected to one end of the air flow path P and, more specifically, communicates with an inlet end of the first flow path P1 in the air flow path P.

The case 110 includes an air outlet 113. The air outlet 113 is a component that discharges the sensed air inside the case 110 to the outside. The air outlet 113 may be disposed on one side of the case 110 and formed to penetrate the wall of the case 110. The air outlet 113 is connected to one end of the air flow path P and, more specifically, communicates with an outlet end of a third flow path P3 in the air flow path P.

Referring to FIG. 1, the air inlet 111 and the air outlet 113 are disposed on one side of the case 110. The present disclosure is not limited thereto and the air inlet 111 and the air outlet 113 may be disposed to be spaced apart from each other on one side and the other side within a range in which the disposition can be easily changed by a person skilled in the art.

The air inlet 111 may be formed to be smaller than the air outlet 113.

Referring to FIG. 1, the air flow path P is formed inside the case 110, and has one end connected to the air inlet 111, and the other end connected to the air outlet 113.

Since the wind-blowing fan 120 is disposed on the air flow path P, the air flow is generated. Since the first sensing module 130 and the second sensing module 140 are disposed on the air flow path P, it is possible to sense dust particles present in flowing air.

The air flow path P includes the first flow path P1, the second flow path P2, and the third flow path P3. The first flow path P1 to the third flow path P3 communicate with each other. Air flow directions in the first flow paths P1 to P3 may be different from each other.

The first flow path P1 is a component that allows air sucked into the dust sensor to flow, and senses dust particles included in the sucked air. The first flow path P1 has the inlet end that communicates with the air inlet 111 and an outlet end that communicates with the second flow path P2.

The air flow direction of the first flow path P1 is different from the air flow direction of the second flow path P2. The first flow path P1 and the second flow path P2 are disposed not to be parallel to each other.

The first sensing module 130 is disposed on the first flow path P1. The first sensing module 130 is disposed on the first flow path P1 and senses dust particles in the air.

The first flow path P1 may be formed to extend downward. That is, the upper end of the first flow path P1 may communicate with the air inlet 111, and the lower end of the first flow path P1 may communicate with the second flow path P2. The first flow path P1 extends downward so that dust can flow according to negative pressure of the wind-blowing fan 120 or can flow according to gravity.

The first flow path P1 may be divided into a first upper flow path P11 and a second lower flow path. The first upper flow path P11 has an inlet end that communicates with the air inlet 111, and an outlet end that communicates with an inlet end of the first lower flow path P12. The first upper flow path P11 may be formed to have a constant cross-sectional area. The first sensing module 130 is preferably disposed on the first upper flow path P11. The first lower flow path P12 has the inlet end that communicates with the first upper flow path P11 and an outlet end that communicates with the second flow path P2. The first lower flow path P12 may be formed so that a cross-sectional area of the outlet end is smaller than that of the inlet end. That is, the cross-sectional area of the first lower flow path P12 may gradually decrease. According to a continuity theorem of fluid, an air flow rate increases at the outlet end of the first lower flow path P12 than at the inlet end of the first lower flow path P12, the dust included in the air has a greater inertia force, and a probability of the dust deviating in a first curved flow path P4 between the first flow path P1 and the second flow path P2 increases.

The first lower flow path P12 may have an inclined surface formed in a direction in which the cross-sectional area of the outlet end becomes smaller than that of the inlet end.

An outer side wall of the first lower flow path P12 may be disposed parallel to an outer side wall of the first upper flow path P11. Preferably, the outer side wall of the first lower flow path P12 may be parallel to the air flow direction of the first upper flow path P11, and an inner side wall of the first lower flow path P12 may form an inclined surface in a direction in which the outlet end approaches the outer side wall. Therefore, when the air flow direction of the first upper flow path P11 is parallel to the outer side wall, the air flow direction of the first lower flow path P12 is not parallel to the air flow direction of the first upper flow path P11 and is gradually biased outward as compared with the air flow direction of the first upper flow path P11. This maximizes centripetal force that is applied to the dust particles in the curved flow path P4.

Referring to FIGS. 1 and 2, the first sensing module 130 is a component that is disposed on the air flow path P and senses dust particles in the air. More specifically, the first sensing module 130 is disposed on the first flow path P1.

The first sensing module 130 may sense dust particles larger than dust particles that can be sensed by the second sensing module 140. For example, the second sensing module 140 accurately senses dust particles of 2.5 μm or less in a range of PM2.5, but cannot accurately sense dust particles of 2.5 μm or more, whereas the first sensing module 130 can relatively accurately sense the particles of 2.5 μm or more.

The first sensing module 130 includes the first light emitting member 131 that radiates the first light. The first light emitting member 131 is disposed on a side surface of the air flow path P, and radiates the first light from the side. More specifically, the first light emitting member 131 is disposed on the side surface of the first flow path P1. For example, when the air flow direction is a z-axis direction, the first light emitting member 131 may radiate the first light in the y-axis direction.

The first light may be light having a wide measurement range or light having a long wavelength so that larger dust can be more accurately sensed as compared with the second light. The first light may be light in the visible region, and may be radiated from an LED.

Preferably, the first light emitting member 131 may be disposed on the inner side of the first flow path P1 to radiate the first light to the outside. The inner side of the first flow path P1 corresponds to one side of the first flow path P1 close to the third flow path P3. That is, the first light emitting member 131 may be disposed between the first flow path P1 and the third flow path P3.

The first sensing module 130 includes the first light reception member 133 that senses the first light radiated by the first light emitting member 131. The first light reception member 133 is disposed on the side surface of the air flow path P and, more specifically, disposed in a direction intersecting both the irradiation direction of the first light emitting member 131 and the air flow direction. For example, when the air flow direction is the z-axis direction and the first light emitting member 131 radiates the first light in the y-axis direction, the first light reception member 133 is disposed in the x-axis direction and senses a scattered part in the first light radiated in the y-axis direction.

Preferably, the first light reception member 133 may be disposed on a rear surface of the first flow path P1. The second light reception member 143 may be disposed on a rear surface of the second flow path P2 like the first light reception member 133. For example, in a first case, the first light emitting member 131 and the second light emitting member 141 may be disposed on the inner side of the air flow path P, and the first light reception member 133 and the second light reception member 143 may be disposed on the rear side of the air flow path P, as in the present disclosure. In a second case, the first light reception member 133 and the second light reception member 143 may be disposed on the inner side, and the first light emitting member 131 and the second light emitting member 141 are disposed on the rear side of the air flow path P. In the second case, there is a problem that the first light emitting member 131 and the second light emitting member 141 perform parallel irradiation and light summation occurs according to scattering, diffraction, or reflection of the light, thereby degrading the accuracy. On the other hand, in the first case, there is an advantage that, since the first light emitting member 131 and the second light emitting member 141 perform irradiation in a direction in which light beams travel away from each other, there is little concern that light beams interfere with each other due to the scattering, diffraction, or reflection.

The first sensing module 130 may include a first condensing lens. The first condensing lens may be disposed at an input end of the first light reception member 133. Since an intensity of LED light is usually lower than that of the laser, the first condensing lens amplifies the intensity of the LED light directed to the first light reception member 133.

The first curved flow path P4 may be formed between the first flow path P1 and the second flow path P2. The first curved flow path P4 may be formed according to a specific radius of curvature between the first flow path P1 and the second flow path P2, and the radius of curvature has a value for maximizing the centripetal force and may be determined according to an experiment.

The first curved flow path P4 has an inlet end that communicates with the outlet end of the first flow path P1, and an outlet end that communicates with the inlet end of the second flow path P2. The first flow path P1 and the second flow path P2 may have different air flow directions, and preferably, the first flow path P1 and the second flow path P2 may have orthogonal air flow directions.

Since a flow direction of the dust particles in the first flow path P1 is different from a flow direction in the second flow path P2, large dust particles collide with an outer side wall of the first curved flow path P4 according to the inertial force, are accumulated on the outer side wall of the first curved flow path P4, and cannot flow through the second flow path P2. However, since the small dust particles also have a small inertial force, the small dust particles can flow through the second flow path P2 without colliding with the outer side wall of the first curved flow path P4.

The air introduced from the inlet end of the first curved flow path P4 and the dust particles included in the air receive a force according to the negative pressure by the wind-blowing fan 120. Further, the dust particles receive gravity, and when a direction of the gravity matches the air flow direction, net force applied to the dust particles further increases. There is an effect that, since the net force is the same as the inertial force, the inertial force of the dust particles further increases when the first flow path P1 extends downward, and since smaller dust particles are filtered in the first curved flow path P4, the sensing accuracy in the second flow path P2 further increases.

In the first curved flow path P4, the air and the dust particles included in the air flow while turning. The turning dust particles receive centripetal force in a radial direction. Since the dust particles receive the centripetal force in the same direction as the above-described inertial force, smaller dust particles are filtered in the first curved flow path P4, such that the sensing accuracy in the second flow path P2 further increases.

A dust cap 150 may be disposed on the first curved flow path P4. A hole is formed through a portion of the outer side wall of the first curved flow path P4, and dust particles accumulated in the first curved flow path P4 can be cleaned through the hole. The dust cap 150 is inserted into the outer side wall of the first curved flow path P4. The dust cap 150 closes the hole when the dust sensor operates, and is removed when the dust sensor is cleaned so that the dust particles accumulated in the first curved flow path P4 is cleaned.

The first flow path P1 is a component that allows the air passing through the first flow path P1 to flow and measures finer dust particles. The inlet end of the second flow path P2 communicates with the first flow path P1 and the outlet end thereof communicates with the third flow path P3. A curved flow path may be disposed in a connection portion between the second flow path P2 and the first flow path P1 or in a connection portion between the second flow path P2 and the third flow path P3.

The second sensing module 140 is disposed on the second flow path P2. The second sensing module 140 is disposed on the second flow path P2 and senses finer particles among dust particles in the air.

The second flow path P2 extends in a direction different from a direction in which the first flow path P1 extends. For example, when the first flow path P1 extends in a vertical direction, the second flow path P2 may extend in a horizontal direction.

The second flow path P2 may be formed to extend laterally. The second flow path P2 may extend in a horizontal direction. The second flow path P2 is laterally disposed so that an influence of the gravity is avoided and the sensing accuracy of the small dust particles is improved.

The second flow path P2 has a constant cross-sectional shape. The second flow path P2 has a constant cross-sectional shape for a constant air flow rate so that the sensing accuracy of the small dust particles is improved.

The second flow path P2 may be formed to have a cross-sectional area smaller than that of the first flow path P1. Accordingly, an air flow rate in the second flow path P2 is higher than that in the first flow path P1. Since the second light has a shorter wavelength than the first light, it is possible to achieve accurate measurement even when the air flow rate is high, and it is possible to save energy by shortening an irradiation time of the second light in consideration of higher energy consumption than that of the first light.

Referring to FIGS. 1 and 4, the second sensing module 140 is a component that is disposed on the air flow path P and senses dust particles in the air. More specifically, the second sensing module 140 is disposed on the second flow path P2.

The second sensing module 140 senses dust particles smaller than the dust particles sensed by the first sensing module 130. For example, the second sensing module 140 may accurately sense dust particles of PM2.5, that is, dust particles of 2.5 μm or less.

The second sensing module 140 includes the second light emitting member 141 that radiates the second light. The second light emitting member 141 is disposed on the side surface of the air flow path P, and radiates the second light from the side surface. More specifically, the second light emitting member 141 is disposed on a side surface of the second flow path P2. For example, when the air flow direction is the y-axis direction, the second light emitting member 141 may radiate the second light in the z-axis direction.

The second light may be light having a shorter wavelength so that smaller dust can be sensed as compared with the first light. The second light may be a laser.

Preferably, the second light emitting member 141 may be disposed on the inner side of the second flow path P2 to radiate the second light to the outside. The inner side of the second flow path P2 corresponds to one side of the second flow path P2 close to the first flow path P1 and the third flow path P3. That is, the second light emitting member 141 may be disposed between the first flow path P1 and the second flow path P2.

The second sensing module 140 includes the second light reception member 143 that senses the second light radiated by the second light emitting member 141. The second light reception member 143 is disposed on the side surface of the air flow path P, and more specifically, disposed in a direction intersecting both the irradiation direction of the second light emitting member 141 and the air flow direction. For example, when the air flow direction in the second flow path P2 is the y-axis direction and the second light emitting member 141 radiates the second light in the z-axis direction, the second light reception member 143 is disposed in the x-direction and senses scattered/diffracted/reflected part in the second light radiated in the z-axis direction.

Preferably, the second light reception member 143 may be disposed on the rear surface of the second flow path P2. The second light reception member 143 and the first light reception member 133 are disposed on the rear surface of the air flow path P, so that the second light emitting member 141 and the first light emitting member 131 can be spatially disposed on the inner side of the air flow path P. Thus, the second light emitting member 141 and the first light emitting member 131 are disposed on the inner side of the air flow path P and radiate the light away from each other to the outside, thereby preventing interference between the first light and the second light.

The second sensing module 140 may include the second condensing lens.

The second sensing module 140 is disposed downstream from the first sensing module 130.

The second sensing module 140 senses dust particles smaller than the dust particles sensed by the first sensing module 130. The second sensing module 140 senses dust particles smaller than the dust particles that can be sensed by the first sensing module 130 in a range narrower than a range that the dust particles can be sensed by the first sensing module 130. That is, the second sensing module 140 has an advantage that the second sensing module 140 can sense dust particles smaller than the dust particles sensed by the first sensing module 130. However, the second sensing module 140 has a disadvantage that the sensing accuracy is low for relatively large dust particles. Further, when large dust particles outside a range in which the second dust sensor can sense dust particles are introduced, there is a problem in that the second dust sensor cannot sense the dust particles.

Therefore, when the second sensing module 140 is disposed downstream from the first sensing module 130 and large dust particles are removed between the second sensing module 140 and the first sensing module 130, the first sensing module 130 can sense large dust particles, and the second sensing module 140 can remove small dust particles. That is, it is possible to dramatically widen a measurement range of dust particles by dualizing measurement of dust particles and spatially dividing a measurement space.

More specifically, the first curved flow path P4 is formed between the second sensing module 140 and the first sensing module 130. In the first curved flow path P4, dust with large particles is filtered and accumulated on the outer side wall due to inertial force, gravity, or centripetal force. Accordingly, since only small dust particles flow in the second sensing module 140, it is possible to accurately measure only the small dust particles.

The third flow path P3 is a component that discharges the measured air to the outside of the dust sensor through the air outlet 113. The third flow path P3 has an inlet end communicating with the second flow path P2 and the outlet end communicating with the air outlet 113.

The third flow path P3 may be disposed to face the first flow path P1. That is, when the air flow direction in the first flow path P1 is downward, an air flow direction in the third flow path P3 may be upward. The first flow path P1, the second flow path P2, and the third flow path P3 may be formed in a ‘U’ shape.

The first light emitting member 131 or the second light emitting member 141 may be disposed between the first flow path P1 and the third flow path P3. The first light emitting member 131 may be disposed on the inner side of the air flow path P and radiate the first light toward the first flow path P1, and the second light emitting member 141 may be disposed on the inner side of the air flow path P and irradiate the second light toward the second flow path P2. A radiating direction of the first light is different from that of the second light and is gradually away from the radiating direction of the second light, thereby achieving an effect that there is no concern that the first radiated light and the second radiated light interfere with each other. Further, since the first light emitting member 131 and the second light emitting member 141 are disposed on the same PCB board, there is also an advantage that a space occupied by the light emitting members inside the case 110 is small so that a space in the case 110 can be efficiently utilized.

The wind-blowing fan 120 is disposed on the third flow path P3. The wind-blowing fan 120 provides the negative pressure to the air flow path P, thereby allowing air to flow.

The third flow path P3 may be formed to extend upward. The outlet end of the third flow path P3 may have a cross-sectional area larger than an inlet end. The present disclosure is not limited thereto and the third flow path P3 may be changed within a range in which the change can be easily adopted by a person skilled in the art.

The outlet end of the third flow path P3 may have the cross-sectional area larger than the inlet end of the first flow path P1. Since the wind-blowing fan 120 is disposed to be biased toward the air outlet 113, the cross-sectional area of the inlet end of the first flow path P1 is designed to be smaller than the cross-sectional area of the outlet end of the third flow path P3 so that air volume and static pressure equal to or larger than a certain value can be secured at the inlet end of the first flow path P1.

A curved flow path P5 may be formed in the connection portion between the second flow path P2 and the third flow path P3. The second curved flow path P5 may be connected to the outlet end of the second flow path P2 and the inlet end of the third flow path P3. An outlet end of the second curved flow path P5 may have a cross-sectional area larger than an inlet end of the second curved flow path P5. The second curved flow path P5 guides the air introduced from the second flow path P2 to the third flow path P3 while changing the air flow direction. The outlet end of the second curved flow path P5 has the cross-sectional area larger than the inlet end of the second curved flow path P5 so that pressure is lowered and dust particles are prevented from being deposited.

The wind-blowing fan 120 is a component that generates the air flow. The wind-blowing fan 120 is disposed on the air flow path P, introduces air present outside the dust sensor into the case 110 through the air inlet, allows the air to flow on the air flow path P, and discharges the air to the outside of the case 110 through the air outlet 113.

Referring to FIG. 1, the wind-blowing fan 120 is disposed on the air flow path P. More specifically, the wind-blowing fan 120 is disposed on the third flow path P3.

The wind-blowing fan 120 may be a cross flow fan. In the cross flow fan, air is introduced in a radial direction and the air is discharged in the radial direction (120). The cross flow fan has a characteristic of uniform discharge of the air. The wind-blowing fan 120 according to the present disclosure is configured of the cross flow fan to allow the air on the flow path to flow at a uniform speed, making it possible to accurately sense dust particles.

Referring to FIG. 1, the wind-blowing fan 120 is disposed to be biased toward the air outlet 113 relative to the air inlet 111. The wind-blowing fan 120 may be disposed in the air inlet 111 to allow the air in the air flow path P to flow according to the positive pressure, or may be disposed in the air outlet 113 to allow the air in the air flow path P to flow according to the negative pressure. The wind-blowing fan 120 according to the present disclosure is disposed at the air outlet 113 to allow the air to flow according to the negative pressure, thereby achieving an effect that the air in the air flow path P can flow at a uniform speed as compared with the air flow according to the positive pressure.

Hereinafter, an operation of the dust sensor according to the present disclosure configured as described above will be described.

Air present outside the dust sensor is introduced into the dust sensor through the air inlet 111, sizes and concentration of dust particles are measured when the air passes through the air flow path P formed inside the dust sensor, and the air is discharged to the outside of the dust sensor through the air outlet 113.

The air is introduced into the dust sensor through the air inlet 111 and flows through the first flow path P1 communicating with the air inlet 111. The air includes dust particles having various sizes. The first sensing module 130 is disposed on the first flow path P1, and the first sensing module 130 senses relatively large dust particles among dust particles having various sizes. For example, the first sensing module 130 mainly senses dust particles of 2.5 μm or more.

The first flow path P1 may be formed to extend downward. Since the first flow path P1 receives gravity in the air flow direction, inertial force increases and the large dust particles collide with the wall in the first curved flow path P4 and are effectively captured.

The first flow path P1 may be divided into the first upper flow path P11 having a constant cross-sectional area and the first lower flow path P12 having a gradually decreasing cross-sectional area. The first upper flow path P11 has the constant cross-sectional area so that a flow rate is constant and low, and the first sensing module 130 can accurately sense the dust particles. Since the second lower flow path has a gradually decreasing cross-sectional area, a flow rate gradually increases and this causes an inertial force so that the large dust particles collide with the wall in the first curved flow path P4 and are effectively captured.

Since the first lower flow path P12 has the inclined surface along which the inner side wall gradually approaches the outer side wall and the cross-sectional area decreases, the air flow direction in the first flow path P1 is gradually biased to the outside. Accordingly, since the centripetal force increases in the first curved flow path P4, the large dust particles collide with the wall and are effectively captured.

The air passing through the first flow path P1 flows through the first curved flow path P4. The air flows through the first curved flow path P4 and the air flow direction changes. Among the dust particles included in the air, large dust particles collide with the outer side wall of the first curved flow path P4 and are captured due to the inertial force, gravity, or centripetal force. The small dust particles do not collide with the outer side wall of the first curved flow path P4 and move toward the second flow path P2. Thus, only dust particles having a relatively small size may flow in the second flow path P2.

The air passing through the first curved flow path P4 flows through the second flow path P2. Among the dust particles included in the air, most of the large dust particles are captured in the first curved flow path P4 and the small dust particles are introduced into the second flow path P2. The second sensing module 140 is disposed on the second flow path P2, and the second sensing module 140 senses relatively small dust particles among the dust particles having various sizes. For example, the second sensing module 140 mainly senses dust particles of 2.5 μm or less. Since most of the relatively large dust particles are captured in the first curved flow path P4, the second sensing module 140 accurately senses fine dust particles, and the accuracy is improved.

The air passing through the second flow path P2 flows through the second curved flow path P5. Since the second curved flow path P5 has the cross-sectional area increasing toward the outlet end, pressure decreases and the dust particles included in the air flow into the third flow path P3 without being deposited.

The air passing through the second curved flow path P5 flows through the third flow path P3. The air introduced into the third flow path P3 is discharged to the outside of the dust sensor through the air outlet 113 via the wind-blowing fan 120.

Preferred embodiments of the present disclosure have been illustrated and described above, but the present disclosure is not limited to the specific embodiments described above, it is apparent that various modifications can be made by those skilled in the art to which the present disclosure pertains without departing from the gist of the present disclosure as claimed in the claims, and these modifications should not be individually understood from the technical spirit or perspective of the present disclosure.

What is claimed is:

1. A dust sensor comprising:
a case having an air inlet and an air outlet formed therein;
an air flow path formed inside the case, having one end connected to the air inlet and the other end connected to the air outlet, and including a first flow path and a second flow path extending in mutually intersecting directions;
a wind-blowing fan disposed on the air flow path;
a first sensing module disposed on the air flow path and configured to sense dust particles in the air; and
a second sensing module disposed on the air flow path, disposed downstream of the first sensing module, and configured to sense dust particles smaller than those sensed by the first sensing module.

2. The dust sensor according to claim 1,
wherein the second flow path extends in a direction different from a direction in which the first flow path extends,
the first sensing module is disposed on the first flow path, and
the second sensing module is disposed on the second flow path.

3. The dust sensor according to claim 2, wherein the second flow path is perpendicular to the first flow path.

4. The dust sensor according to claim 2, wherein the air flow path includes a curved flow path formed in a connection portion between the first flow path and the second flow path.

5. The dust sensor according to claim 1, wherein the first flow path includes
a first upper flow path having an inlet end communicating with the air inlet, formed to have a constant cross-sectional area, and having the first sensing module disposed thereon; and
a first lower flow path having an inlet end communicating with the first upper flow path, an outlet end of the first lower flow path having a cross-sectional area smaller than the inlet end.

6. The dust sensor according to claim 5, wherein the first lower flow path includes an outer side wall disposed parallel to an outer side wall of the first upper flow path.

7. The dust sensor according to claim 1, wherein the first flow path includes an upper end communicating with the air inlet, extends downward, and includes a lower end communicating with the second flow path.

8. The dust sensor according to claim 1, wherein the first sensing module includes
a first light emitting member disposed on a side surface of the air flow path and configured to radiate first light from the side; and
a first light reception member disposed in a direction intersecting both an irradiation direction of the first light emitting member and the air flow direction and configured to sense the first light.

9. The dust sensor according to claim 1, wherein the second sensing module includes
a second light emitting member disposed on a side surface of the air flow path and configured to radiate second light from the side; and
a second light reception member disposed in a direction intersecting both an irradiation direction of the second light emitting member and the air flow direction and configured to sense the second light.

10. The dust sensor according to claim 1, wherein the wind-blowing fan is disposed closer to the air outlet relative to the air inlet.

11. The dust sensor according to claim 1,
wherein the air flow path further includes a third flow path communicating with an outlet end of the second flow path, and
the wind-blowing fan is disposed on the third flow path.

12. The dust sensor according to claim 11, wherein the third flow path is formed so that a cross-sectional area of an outlet end is larger than that of an inlet end.

13. The dust sensor according to claim 11, wherein the air flow path includes a curved flow path formed in a connection portion between the second flow path and the third flow path.

14. The dust sensor according to claim 1, wherein the air flow path includes
a first flow path connected to the air inlet;
a third flow path connected to the air outlet and facing the first flow path; and
a second flow path connecting the first flow path to the third flow path.

15. The dust sensor according to claim 14,
wherein the first sensor and the second sensor include a first light emitting member and a second light emitting member configured to radiating light, respectively, and
the first light emitting member or the second light emitting member is disposed between the first flow path and the third flow path.

16. The dust sensor according to claim 2, wherein a cross-sectional area of the second flow path is smaller than that of the first flow path.
